(19) United States
(12) Patent Application Publication
(10) Pub. No.: US 2022/0176175 A1
(43) Pub. Date: Jun. 9, 2022

(54) Wildfire Facility Structure Protection Sprinkler

(71) Applicant: Bob Simon Shane Swart, Grand Forks (CA)

(72) Inventor: Bob Simon Shane Swart, Grand Forks (CA)

(21) Appl. No.: 17/547,061

(22) Filed: Dec. 9, 2021

Related U.S. Application Data
(63) Continuation-in-part of application No. 29/780,946, filed on Apr. 27, 2021.
(60) Provisional application No. 63/123,342, filed on Dec. 9, 2020.

(51) Int. Cl. A62C 3/02; A62C 35/68

(52) U.S. Cl. CPC A62C 3/0292; A62C 35/68

(57) ABSTRACT

A wildfire protection sprinkler device suitable for mitigating wildfires by dispensing water along dry brush or any other flammable media is presented. This turns the wildfire prone area into a dampened state, therefore protecting the affected area from the wildfire. The wildfire protection sprinkler comprises a housing, and a sprinkler assembly. The housing comprises a sprinkler opening, and an inlet aperture. The sprinkler assembly comprises a sprinkler stand, a sprinkler head, a flow control valve, and an inlet tube. The sprinkler assembly is positioned within the housing. The sprinkler stand is connected between the sprinkler head and the inlet tube. The inlet aperture traverses through the housing. The inlet tube traverses from the inlet aperture to the sprinkler stand. The sprinkler stand, the sprinkler head, the flow control valve, and the inlet tube are in fluid communication with each other.

### FIELD OF THE INVENTION

The present invention relates generally to sprinkler systems, specifically to a sprinkler system that is stored within a hogshead style barrel to stay out of sight. The present invention can be used in wineries and other similar venues.

### BACKGROUND OF THE INVENTION

In this present day we are presented with a multitude of environmental hazards ranging from earthquakes to tsunamis. One environmental disaster particularly common in the western regions of the United States are wildfires. Many of these wildfires if not contained at the first outbreak can spread extremely quickly causing widespread destruction of the surrounding environment and property. Residents of the affected areas are familiar with these hazards and have used many methods in an attempt to prevent the spread of wildfire outbreaks. One common method is to create a humidity bubble around the surrounding area which raises the relative humidity above the ignition point ensuring that the wildfires cannot spread as easily.

Various areas have combated wildfires with this method by either having the sprinkler equipment on standby or by installing sprinkler systems around the surrounding properties. These situations however cause a few problems. The first problem being that the sprinkler equipment does not blend in with the rest of the surrounding scenery. This creates a negative aesthetic for the brand of the company that owns the venue or property when a customer is attempting to enjoy a nice evening at a winery, or similar venue, and is constantly being distracted by a large mechanical sprinkler system taking away from the experience of the day. The wildfire facility structure protection sprinkler has come up with a solution to this problem by creating a sprinkler system that is capable of being quickly taken apart and stored in a hogshead style barrel which will blend in with the surrounding scenery, allowing the customers to enjoy their time.

The second problem is that other venues may store their fire protection equipment in a storage facility and then access this facility, haul and set up the fire protection equipment once news of a fire in the area has reached them. This method causes the user to take a considerable amount of time to set up and prepare the land for the incoming fire. The wildfire facility structure protection sprinkler has come up with a solution to this problem as well. Due to the inconspicuous design the wildfire facility structure protection sprinkler, multiple units of the present invention can be positioned around the property year-round, thus lowering labor costs as well as saving time for set up. In addition to the wildfire facility structure protection sprinkler placement, the design allows for the components of the unit to be easily and quickly put together in a few steps. This allows the user to connect a hose to the system, open the top of the barrel, connect the sprinkler head and turn on the flow control valve, thus making the wildfire facility structure protection sprinkler completely operational in under one minute.

### SUMMARY OF THE INVENTION

The present invention, the wildfire facility structure protection sprinkler, intends to assist in the protection of land and property from wildfires. The wildfire facility structure protection sprinkler intends to achieve this by creating a wet and humid environment by spraying saturated fuels via the sprinkler system. The present invention also seeks to provide the user with an easy installation set-up by allowing the wildfire facility structure protection sprinkler to be fully operational in under one minute with only a few steps needed. The present invention is also designed to fit into hogshead style barrels allowing for a year-round positioning on the property and creating an aesthetic that blends and compliments the surrounding environment and scenery.

### BRIEF DESCRIPTION OF THE DRAWINGS

FIG. 1 is a top perspective view of the present invention.

FIG. 2 is a front view of the present invention.

FIG. 3 is a top-front exploded view of the present invention.

FIG. 4 is a top-rear exploded view of the present invention.

FIG. 5 is a top perspective view of the present invention in a storage configuration.

FIG. 6 is a front view of the present invention in accordance with another embodiment.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

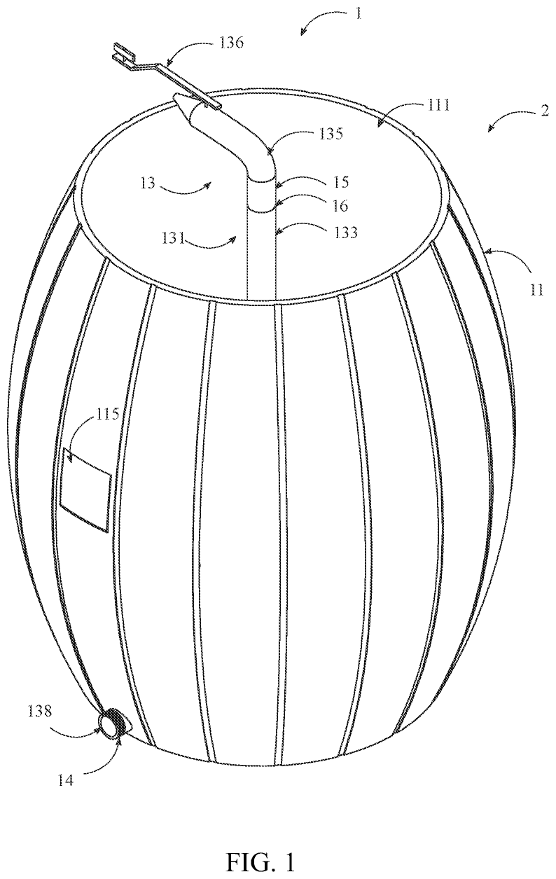

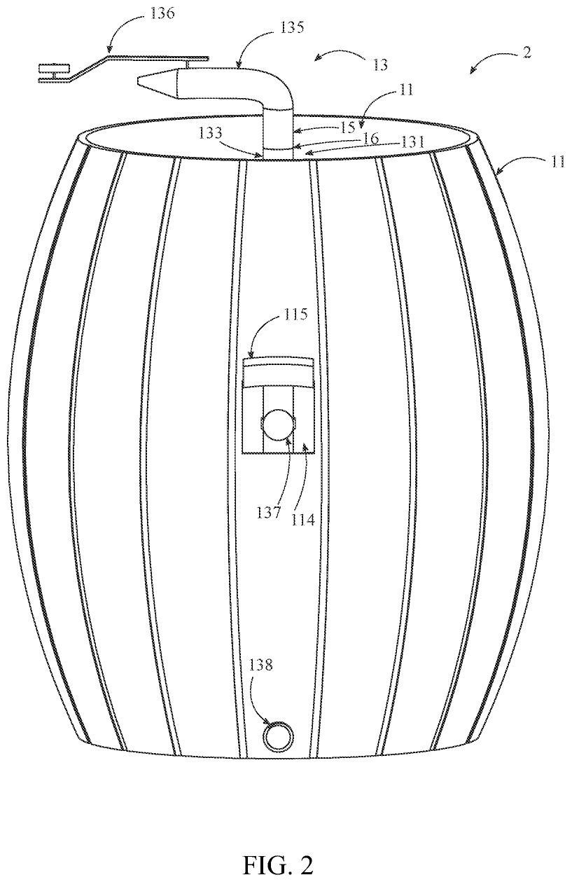

The present invention is a wildfire protection sprinkler device 1 suitable for mitigating wildfires by dispensing water along dry brush or any other flammable media. This turns the wildfire prone area into a dampened state, therefore protecting the affected area from the wildfire. In reference to FIGS. 1-5, the wildfire protection sprinkler device 1 comprises a housing 11, and a sprinkler assembly 13. The housing 11 comprises a sprinkler opening 111, and an inlet aperture 112. The sprinkler assembly 13 comprises a sprinkler stand 131, a sprinkler head 135, a flow control valve 137, and an inlet tube 138. The sprinkler assembly 13 is positioned within the housing 11. The sprinkler stand 131 is connected between the sprinkler head 135 and the inlet tube 138. The flow control valve 137 is connected between the sprinkler head 135 and the inlet tube 138. The inlet aperture 112 traverses through the housing 11. In the preferred embodiment, the inlet aperture 112 is positioned to the bottom of the housing 11, opposite to the sprinkler opening 111. The inlet tube 138 traverses from the inlet aperture 112 to the sprinkler stand 131. The sprinkler stand 131, the sprinkler head 135, the flow control valve 137, and the inlet tube 138 are in fluid communication with each other. In the preferred embodiment, the sprinkler stand 131 projects the sprinkler head out of the sprinkler opening 111 in a deployed configuration 2, as shown in FIGS. 1-3.

In the preferred embodiment, the housing 11 is constructed out of a wine barrel such that the housing 11 complements the atmospheric decor and design of area the wildfire protection sprinkler device 1 is situated in. In the preferred embodiment, the housing 11 may take the form of any other suitable shape or appearance that complements the atmospheric decor and design of any area. Such shapes and appearances include, but are not limited to wooden storage boxes, water barrels, animal feeding stations, fake trees, or any other suitable shape and appearance. The housing 11 may be situated in areas such as, but not limited to vineyards, farms, wildlife preserves, zoos, botanical gardens, or any other suitable area. In the preferred embodiment, the housing 11 serves as the primary chassis and receptacle that secures the components that constitutes the wildfire protection sprinkler device 1. In the preferred embodiment, the sprinkler assembly 13 takes the form of a wildfire sprinkler system suitable in dispersing water along a targeted area. The sprinkler assembly 13, specifically the sprinkler head 135 is projected out of the sprinkler opening 111 such that water is dispersed from the sprinkler opening 111 side of the housing 11 in the deployed configuration 2 as shown in FIGS. 1-3. In the preferred embodiment, the sprinkler stand 131 serves as the main frame of the sprinkler assembly 13 that secures the sprinkler assembly 13 within the housing 11 as well as project the sprinkler head 135 out of the sprinkler opening 111. In the preferred embodiment, the sprinkler head 135 serves as a sprinkler nozzle element that disperses water in a specified flow pattern suitable for dampening an area. The specified flow pattern takes the form of any suitable flow pattern including, but not limited to fan flow patterns, spiral flow dispersion patterns, misters, or any other suitable dispersion pattern.

In the preferred embodiment, the flow control valve 137 takes the form of any suitable valve implement used to control the flow of water along the sprinkler assembly 13. In the preferred embodiment, the flow control valve 137 may take the form of a manual turn ball valve. In another embodiment, the flow control valve 137 may take the form of a remotely controlled solenoid valve. In the preferred embodiment, the inlet tube 138 serves as the sprinkler assembly water inlet, allowing the user to install a water source along the tube inlet portion of the sprinkler assembly 13.

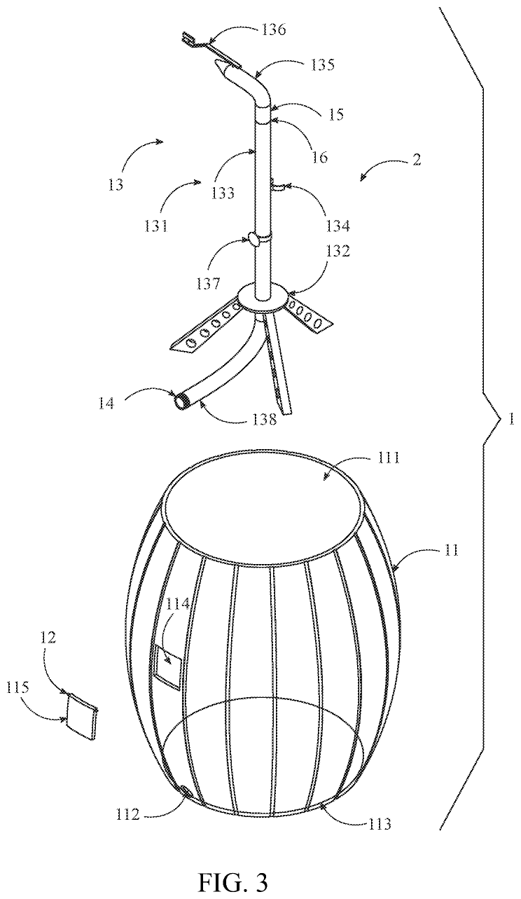

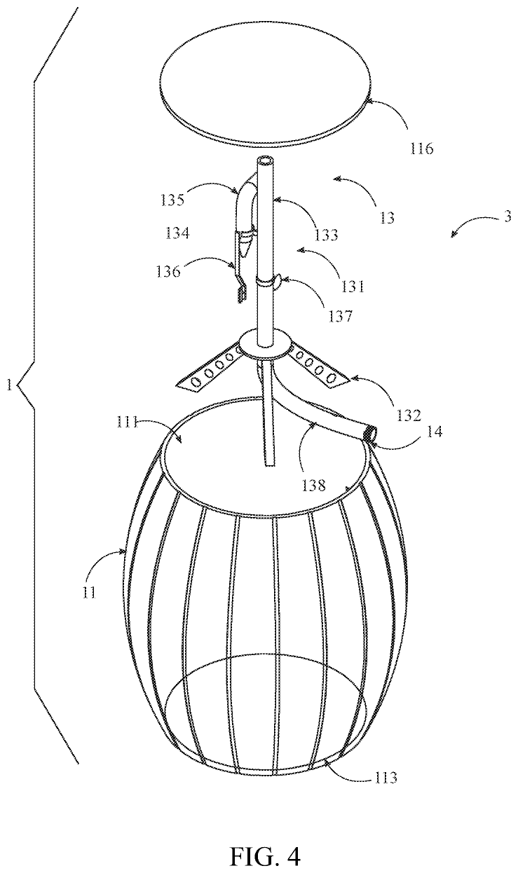

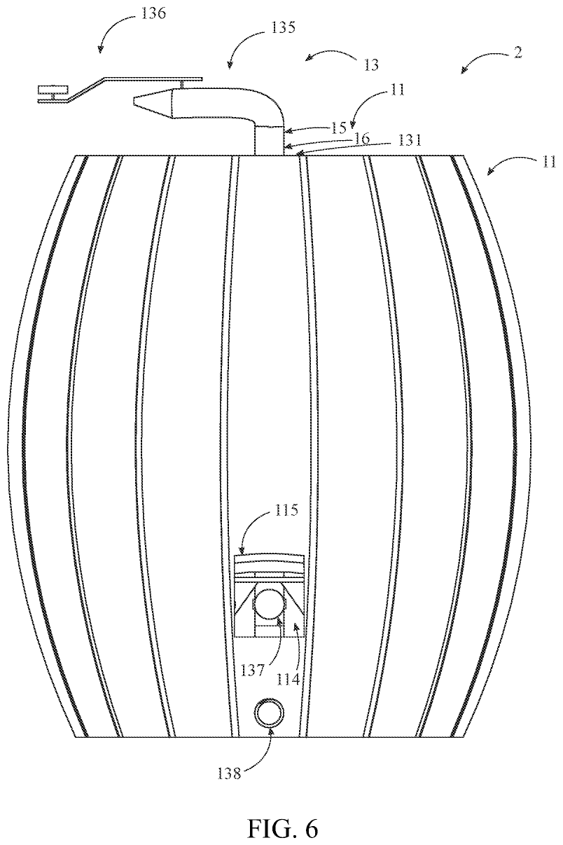

The housing 11 further comprises a housing base 113, as shown in FIGS. 3-4. The housing base 113 is positioned opposite to the sprinkler opening 111 along the housing 11. The sprinkler assembly 13 traverses from the housing base 113 to the sprinkler opening 111. The housing base 113 takes the form of the bottom portion of the housing 11. In reference to FIGS. 1-3 and 5, the housing 11 further comprises an access opening 114 and an access panel 115. The access opening 114 traverses through the housing 11, where the access opening 114 is configured to facilitate access of the flow control valve 137 from the outside of the housing 11. The access panel 115 is delineated along the access opening 114. The access panel 115 is hingedly connected to the access opening 114 through a hinge fastener 12. In the preferred embodiment, the access opening 114 allows user access from the housing 11 to the flow control valve 137. The access panel 115 shrouds the access opening 114 such that debris or loose articles do not seep through the access opening 114 and into the housing 11. Additionally, the access panel 115 is integrated along the housing 11, such that the access opening 114 appears discrete yet accessible to the user. In another embodiment, the access opening 114 is positioned along the bottom portion of the housing 11, adjacent to the inlet aperture 112 to align with the flow control valve 137 connected adjacent to the inlet tube 138, as shown in FIG. 6. In this embodiment, the bottom placed aforementioned components prevents kinks and blockages along the sprinkler assembly 13. In various embodiments, the flow control valve 137, the access panel 115, and the access opening 114 may be positioned in any portion of the housing 11, such as, but not limited to the top portion, side portions, or any other portion of the housing 11.

In the preferred embodiment, the sprinkler head 135 comprises a deflector 136, as shown in FIGS. 1-4. The deflector 136 is positioned adjacent to the sprinkler head 135. The deflector 136 is in fluid communication with the sprinkler head 135. The deflector 136 serves as a dispersal implement acting along the sprinkler head 135 such that water emitting out of the sprinkler head 135 is dispersed in the aforementioned specified flow pattern. In the preferred embodiment, the sprinkler stand 131 comprises a sprinkler base 132, as shown in FIGS. 3-4. The sprinkler base 132 is positioned adjacent to the housing base 113. The sprinkler base 132 is connected adjacent to the inlet tube 138. In the preferred embodiment, the sprinkler base 132 takes the form of a stabilizing implement that aids in securing the sprinkler assembly 13 along the housing base 113. In the preferred embodiment, the sprinkler base 132 takes the form of a legged base but may take the form of any other suitable base platform.

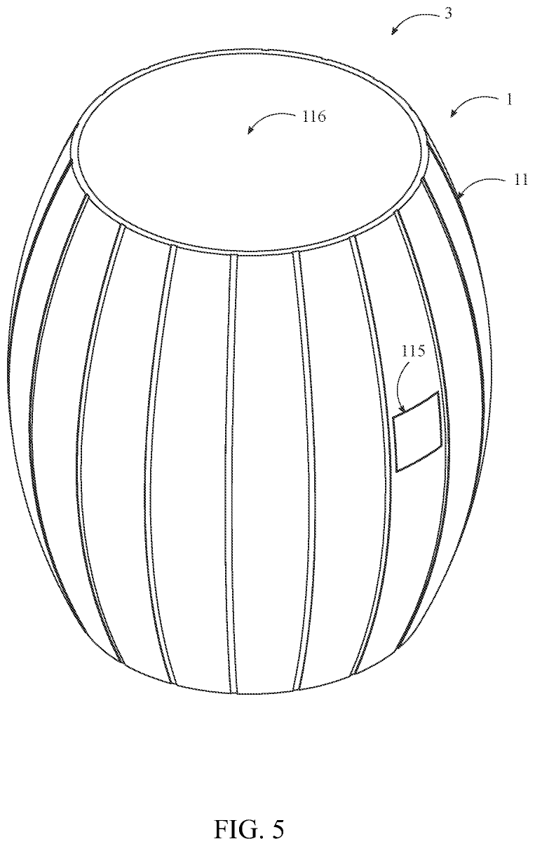

In the preferred embodiment, the sprinkler stand 131 comprises a tube extension 133, as shown in FIGS. 1-4. The tube extension 133 is connected between the inlet tube 138 and the sprinkler head 135. The tube extension 133 traverses from the inlet tube 138 to the sprinkler opening 111. In the preferred embodiment, the tube extension 133 takes the form of a pipe extension that projects the sprinkler head 135 out of the sprinkler opening 111. The sprinkler stand 131 comprises a sprinkle-head holder 134, as shown in FIGS. 3-4. The sprinkle-head holder 134 is connected adjacent to the sprinkler stand 131, where the sprinkle-head holder 134 is configured to attach the sprinkler head 135 along the sprinkler stand 131 in a storage configuration 3. More specifically, the sprinkle-head holder 134 is connected adjacent to the tube extension 133, where the sprinkle-head holder 134 is configured to attach the sprinkler head 135 along the tube extension 133 in a storage configuration 3, as shown in FIG. 4. In the preferred embodiment, the housing 11 further comprises a cover 116, as shown in FIGS. 4-5. The cover 116 is delineated along the sprinkler opening 111. The cover 116 is removably attached to the sprinkler opening 111. In the preferred embodiment, the cover 116 takes the form of a clamshell top cover 116 that attaches along the sprinkler opening 111 in the storage configuration 3, as shown in FIG. 5.

In the preferred embodiment, the wildfire protection sprinkler device 1 further comprises a hose connecting element 14, as shown in FIGS. 1 and 3. The hose connecting element 14 is positioned adjacent to the inlet tube 138, opposite to the sprinkler stand 131. The hose connecting element 14 allows the connection of a water supply hose to the inlet tube 138. In the preferred embodiment, the hose connection element takes the form of threaded hose fittings but may take the form of any other suitable hose connection element. In the preferred embodiment, the sprinkler head 135 is rotatably connected adjacent to the sprinkler stand 131 through a rotatable coupler 15, as shown in FIGS. 1-3. The rotatable coupler 15 allows the sprinkler head 135 to freely rotate along the sprinkler stand 131. Working in conjunction with the deflector 136, the sprinkler head 135 will rotate and disperse the specified flow pattern in a circular motion, providing 360-degree dispersal of the specified flow pattern along the affected area that the wildfire protection sprinkler device 1 is situated in. In the preferred embodiment, the sprinkler head 135 is removably attached adjacent to the sprinkler stand 131 through a quick detach connector 16, as shown in FIGS. 1-3. This allows the sprinkler head 135 to quickly detach off the sprinkler stand 131 such that the sprinkler head 135 attaches to the sprinkle-head holder 134 in the storage configuration 3.

Although the invention has been explained in relation to its preferred embodiment, it is to be understood that many other possible modifications and variations can be made without departing from the spirit and scope of the invention as hereinafter claimed.

What is claimed is:

1. A wildfire protection sprinkler device comprising:
a housing;
a sprinkler assembly;
the housing comprising a sprinkler opening, and an inlet aperture;
the sprinkler assembly comprising a sprinkler stand, a sprinkler head, a flow control valve, and an inlet tube;
the sprinkler assembly being positioned within the housing;
the sprinkler stand being connected between the sprinkler head and the inlet tube;
the inlet aperture traversing through the housing;
the inlet tube traversing from the inlet aperture to the sprinkler stand; and
the sprinkler stand, the sprinkler head, the flow control valve, and the inlet tube being in fluid communication with each other.

2. The wildfire protection sprinkler device as claimed in claim 1, wherein the housing is constructed out of a wine barrel.

3. The wildfire protection sprinkler device as claimed in claim 1 comprising:
the housing further comprising a housing base;
the housing base is positioned opposite to the sprinkler opening along the housing; and
the sprinkler assembly traversing from the housing base to the sprinkler opening.

4. The wildfire protection sprinkler device as claimed in claim 1 comprising:
the housing further comprising an access opening and an access panel;
the access opening traversing through the housing, wherein the access opening is configured to facilitate access of the flow control valve from the outside of the housing;
the access panel being delineated along the access opening; and
the access panel being hingedly connected to the access opening through a hinge fastener.

5. The wildfire protection sprinkler device as claimed in claim 1 comprising:
the sprinkler head comprising a deflector;
the deflector being positioned adjacent to the sprinkler head; and
the deflector being in fluid communication with the sprinkler head.

6. The wildfire protection sprinkler device as claimed in claim 1 comprising:
the housing further comprising a housing base;
the sprinkler stand comprising a sprinkler base;
the housing base being positioned terminally opposite from the sprinkler opening along the housing;
the sprinkler base being positioned adjacent to the housing base; and
the sprinkler base being connected adjacent to the inlet tube.

7. The wildfire protection sprinkler device as claimed in claim 1 comprising:
the sprinkler stand comprising a tube extension;
the tube extension being connected between the inlet tube and the sprinkler head; and
the tube extension traversing from the inlet tube to the sprinkler opening.

8. The wildfire protection sprinkler device as claimed in claim 1 comprising:
the sprinkler stand comprising a sprinkle-head holder; and
the sprinkle-head holder being connected adjacent to the sprinkler stand, wherein the sprinkle-head holder is configured to attach the sprinkler head along the sprinkler stand in a storage configuration.

9. The wildfire protection sprinkler device as claimed in claim 1 comprising:
the housing further comprising a cover;
the cover being delineated along the sprinkler opening; and
the cover being removably attached to the sprinkler opening.

10. The wildfire protection sprinkler device as claimed in claim 1 comprising:
a hose connecting element;
the hose connecting element being positioned adjacent to the inlet tube, opposite to the sprinkler stand.

11. The wildfire protection sprinkler device as claimed in claim 1 comprising:
the housing further comprising a housing base;
the housing further comprising an access opening;
the housing base being positioned terminally opposite from the sprinkler opening along the housing; and
the access opening traversing through the housing, wherein the access opening is configured to facilitate access of the flow control valve from the outside of the housing.

12. The wildfire protection sprinkler device as claimed in claim 1 comprising:
the housing further comprising a housing base;
the housing further comprising an access opening and an access panel;
the housing base being positioned terminally opposite from the sprinkler opening along the housing;
the access opening traversing through the housing, wherein the access opening is configured to facilitate access of the flow control valve from the outside of the housing;
the access panel being delineated along the access opening; and
the access panel being hingedly connected to the access opening through a hinge fastener.

13. The wildfire protection sprinkler device as claimed in claim 1 comprising:
the housing further comprising a housing base;
the sprinkler stand comprising a sprinkler base and a tube extension;
the housing base being positioned terminally opposite from the sprinkler opening along the housing;
the tube extension being connected between the inlet tube and the sprinkler head; and
the tube extension traversing from the inlet tube to the sprinkler opening;
the sprinkler base being positioned adjacent to the housing base; and
the sprinkler base being connected adjacent to the inlet tube.

14. The wildfire protection sprinkler device as claimed in claim 1 comprising:
the sprinkler stand comprising a tube extension;
the sprinkler stand comprising a sprinkle-head holder;
the tube extension being connected between the inlet tube and the sprinkler head;
the tube extension traversing from the inlet tube to the sprinkler opening.
the sprinkle-head holder being connected adjacent to the tube extension, wherein the sprinkle-head holder is configured to attach the sprinkler head along the tube extension in a storage configuration.

15. The wildfire protection sprinkler device as claimed in claim 1 comprising:
the housing further comprising a housing base;
the sprinkler stand comprising a sprinkler base and a sprinkle-head holder;
the housing base being positioned terminally opposite from the sprinkler opening along the housing;
the sprinkler base being positioned adjacent to the housing base;
the sprinkler base being connected adjacent to the inlet tube; and
the sprinkle-head holder being connected adjacent to the sprinkler stand, wherein the sprinkle-head holder is configured to attach the sprinkler stand along the tube extension in a storage configuration.

16. The wildfire protection sprinkler device as claimed in claim 1 comprising:
the housing further comprising a housing base;
the sprinkler stand comprising a sprinkler base, a tube extension, and a sprinkle-head holder;
the housing base being positioned terminally opposite from the sprinkler opening along the housing;
the sprinkler base being positioned adjacent to the housing base;
the sprinkler base being connected adjacent to the inlet tube;
the tube extension being connected between the inlet tube and the sprinkler head;
the tube extension traversing from the inlet tube to the sprinkler opening.
the sprinkle-head holder being connected adjacent to the tube extension, wherein the sprinkle-head holder is configured to attach the sprinkler head along the tube extension in a storage configuration.

17. The wildfire protection sprinkler device as claimed in claim 1 comprising:
the sprinkler head being rotatably connected adjacent to the sprinkler stand through a rotatable coupler.

18. The wildfire protection sprinkler device as claimed in claim 1 comprising:
the sprinkler head being removably attached adjacent to the sprinkler stand through a quick detach connector.

19. A wildfire protection sprinkler device comprising:
a housing;
a sprinkler assembly;
the housing comprising a sprinkler opening, an inlet aperture, an access opening and an access panel;
the sprinkler assembly comprising a sprinkler stand, a sprinkler head, a flow control valve, and an inlet tube;
the sprinkler assembly being positioned within the housing;
the sprinkler stand being connected between the sprinkler head and the inlet tube; the inlet aperture traversing through the housing;
the flow control valve being connected between the sprinkler head and the inlet tube;
the inlet tube traversing from the inlet aperture to the sprinkler stand; and
the sprinkler stand, the sprinkler head, the flow control valve, and the inlet tube being in fluid communication with each other.
the access opening traversing through the housing, wherein the access opening is configured to facilitate access of the flow control valve from the outside of the housing;
the access panel being delineated along the access opening; and
the access panel being hingedly connected to the access opening through a hinge fastener.

20. A wildfire protection sprinkler device comprising:
a housing;
a sprinkler assembly;
the housing comprising a sprinkler opening, an inlet aperture, and a housing base;
the sprinkler assembly comprising a sprinkler stand, a sprinkler head, a flow control valve, and an inlet tube;
the sprinkler stand comprising a sprinkler base, a tube extension, and a sprinkle-head holder;
the sprinkler assembly being positioned within the housing;
the sprinkler stand being connected between the sprinkler head and the inlet tube;
the flow control valve being connected between the sprinkler head and the inlet tube;
the inlet aperture traversing through the housing;
the inlet aperture traversing through the housing;
the inlet tube traversing from the inlet aperture to the sprinkler stand;
the sprinkler stand, the sprinkler head, the flow control valve, and the inlet tube being in fluid communication with each other;
the housing base being positioned terminally opposite from the sprinkler opening along the housing;
the sprinkler base being positioned adjacent to the housing base;
the sprinkler base being connected adjacent to the inlet tube;
the tube extension being connected between the inlet tube and the sprinkler head;
the tube extension traversing from the inlet tube to the sprinkler opening.
the sprinkle-head holder being connected adjacent to the tube extension, wherein the sprinkle-head holder is configured to attach the sprinkler head along the tube extension in a storage configuration.
